(19) United States
(12) Patent Application Publication
(10) Pub. No.: US 2004/0044709 A1
(43) Pub. Date: Mar. 4, 2004

(54) System and method for optical data communication

(76) Inventors: Florencio Cabrera, New York, NY (US); Matthew Mason, Litchfield, NH (US); Daniel Colby, Milford, NH (US)

Correspondence Address: BAKER & BOTTS, 30 ROCKEFELLER PLAZA, NEW YORK, NY, 10112

(21) Appl. No.: 10/233,717

(22) Filed: Sep. 3, 2002

(51) Int. Cl. G06E 1/04

(52) U.S. Cl. 708/191

(57) ABSTRACT

A system for data communication in a space illuminated by a plurality of illumination sources that are powered by a common power feed. The system includes a power modulation unit which is interposed in the common power feed, upstream of each of the illumination sources. The power modulation unit induces a change in the signal of the power feed in response to received data and effects variations in illumination intensity in the space provided by the illumination sources. The data is provided by a data source computer. At least one optical receiver is in the illuminated space and is in optical communication with at least one of the illumination sources. The optical receiver is responsive to changes in the incident light from the illumination sources resulting from the power modulation unit. The system can be used to communicate and display product data in an electronic shelf tag system.

### FIELD OF THE INVENTION

The present invention relates generally to data communications systems and more particularly relates to data communications systems which employ modulated light as the carrier of information.

### BACKGROUND OF THE INVENTION

It is often desirable to provide a communication system within an environment to broadcast data from a common source to numerous receiver endpoints. It is known that such systems can use various forms of wireless communication in order to broadcast data from the source to the receivers. A common form of wireless communication is the use of radio frequency (RF) systems to transmit and receive data. In a one-to-many broadcast system, the cost of the system is largely determined by the cost of the receiver. For highly cost sensitive applications, an RF receiver may be cost prohibitive.

It is well known that the intensity of a light source can be modulated in order to transmit information from the light source to a remote point which is generally in the line of sight of the light source. The modulated light from the source is generally received by an optical detector, such as a photo diode or solar cell, and the information content is extracted by an appropriate demodulator.

U.S. Pat. No. 5,193,201 is directed to a system for transmitting data from a host computer by a modulated light source to a remote data processing system which is responsive to the light source. The '201 patent discloses that the light source can be a conventional light, such as a fluorescent lamp, which has a ballast interposed between the bulb and the power main. The data is provided downstream of the ballast, i.e., between the ballast and the bulb, such that each light source is separately coupled to the host computer. In the '201 patent, the data is provided to a transformer which is coupled between the ballast and the bulb, i.e., downstream of the ballast with respect to the AC power main. This method of providing data to the light source can be disadvantageous when a space is illuminated by a number of bulbs, since a transformer or specialized ballast with a data input port must be installed for each bulb or group of bulbs. In installations such as large retail stores, this can result in the need to install hundreds of transformers or new ballasts.

It is also known that product information can be provided at the point-of-scale using programmable shelf “tags” which include an electronic display. Such electronic tags can be programmed to display product and price information and have an advantage that this information can be changed relatively easily. In this regard, electronic shelf tags which use a radio frequency communication link to send and receive product data are generally known. A drawback with known shelf tag systems that use an RF link to transport product data to the tag is cost owing to the RF receiver that is required in each tag. Accordingly, it would be beneficial to provide an electronic shelf tag system which received programming data in a more cost effective manner.

### SUMMARY OF THE INVENTION

It is an object of the present invention to provide a communication system for an illuminated environment in which the light sources in the environment are modulated using a common power main signal.

It is a further object of the present invention to provide a communication system using the illumination system for the environment and which does not require the use of customized ballast circuits.

It is another object to provide an electronic shelf tag system using the standard illumination system of the retail setting in a data communication network.

In accordance with the present invention, a system for data communication in a space illuminated by a plurality of illumination sources that are powered by a common power feed is provided. The system includes a power modulation unit which is interposed in the common power feed, upstream of each of the illumination sources. The power modulation unit induces a change in the signal of the power feed in response to received data. The changes induced on the power feed effect variations in illumination in the space provided by the illumination sources. The received data is provided to the power modulation unit by a data source computer. At least one optical receiver is in the illuminated space and is in optical communication with at least one of the illumination sources. The optical receiver is responsive to changes in the incident light from the illumination sources resulting from the power modulation unit.

A first embodiment of the power modulation unit includes a transformer having a tapped primary and a secondary. A switching circuit is interposed between the AC power main input terminals and the transformer, such that the switching circuit selectively connects the AC power main terminals to either the tapped portion of the transformer winding or to the full transformer winding in response to a received external data signal such that turns ratio of the transformer is altered. The voltage at the secondary of the transformer is modulated in response to the received external data in that the peak amplitude of the signal will be varied based upon the ratio of the turns in the tapped portion of the transformer winding to the full winding. The tapped winding can be either the primary winding or secondary winding of the transformer.

Preferably, the power modulation unit further includes an AC power main sampling circuit which generates a clock signal that is synchronized to the AC power main signal.

In one embodiment of the power modulation unit, the switching circuit is formed with a pair of silicon controlled rectifiers with the gate terminals coupled to the data signal and the complement of the data signal respectively. The silicon controlled rectifiers form a single pole, double throw switch which can modulate each half cycle of the AC power main signal.

In an alternate embodiment of the power modulation unit, the switching circuit can be formed as a single pole, double throw switch fabricated from MOSFET devices, or other non-latching semiconductors. The use of FET switching devices has the advantage that the switch can be operated a number of times during each half cycle of the AC power main signal to provide for data rates that exceed twice the frequency of the AC power main signal.

An optical receiver in accordance with the present invention preferably is formed as a compact, multilayer design that includes a liquid crystal display layer for displaying information to a user. At least a portion of the light which is incident on the liquid crystal display layer is transmitted through to a transflective layer positioned behind the liquid crystal display layer. The transflective layer provides contrast for the liquid crystal display layer while allowing a substantial portion of the incident light to be transmitted therethrough. A photovoltaic layer is positioned behind the liquid crystal display layer. The photovoltaic layer receives at least a portion of the light incident upon the receiver and generates a voltage in response thereto. A circuit layer is positioned behind the photovoltaic layer. The voltage from the photovoltaic layer is preferably used to power the optical receiver circuit, including the liquid crystal display layer, and is also coupled to a demodulator to recover the transmitted data. Preferably, the demodulator is formed using a computer processor operating under the control of appropriate software.

Also in accordance with the present invention is a method of transmitting data within a network space. The method includes illuminating the network space with a plurality of illumination sources powered by a common alternating current power main and applying a modulation signal to the alternating current power main such that the illumination intensity of each of the plurality of illumination sources is substantially simultaneously modulated in response thereto. In the case where one or more of the illumination sources has an associated ballast, the modulation signal is applied upstream of the ballast.

### BRIEF DESCRIPTION OF THE DRAWING

Further objects, features and advantages of the invention will become apparent from the following detailed description taken in conjunction with the accompanying figures showing illustrative embodiments of the invention, in which:

FIG. 1 is a block diagram of a communication system using the illumination system for an environment to transmit data by modulating a common power main supplying the illumination system;

FIG. 2 is a simplified schematic diagram illustrating an embodiment of a circuit for modulating the power main signal for use in connection with the system of FIG. 1;

FIG. 3 is a simplified schematic diagram illustrating an embodiment of a switching circuit for modulating the power main signal for use in connection with the system of FIG. 1; and

FIGS. 4A, 4B and 4C are timing diagrams illustrating the modulation of a power main signal in accordance with one embodiment of the invention.

FIG. 5 is a schematic diagram illustrating an embodiment of a switching circuit for modulating the power main signal for use in connection with the system of FIG. 1 in accordance with the timing of FIG. 4;

FIG. 6 is a simplified schematic diagram of an optical receiver and data display device in accordance with the present invention;

FIG. 7 is a cross sectional view illustrating a preferred fabrication of an optical receiver and data display device in accordance with the present invention; and

FIG. 8 is a simplified block diagram illustrating a portable tag editor.

Throughout the figures, the same reference numerals and characters, unless otherwise stated, are used to denote like features, elements, components or portions of the illustrated embodiments. Moreover, while the subject invention will now be described in detail with reference to the figures, it is done so in connection with the illustrative embodiments. It is intended that changes and modifications can be made to the described embodiments without departing from the true scope and spirit of the subject invention as defined by the appended claims.

### DETAILED DESCRIPTION OF PREFERRED EMBODIMENTS

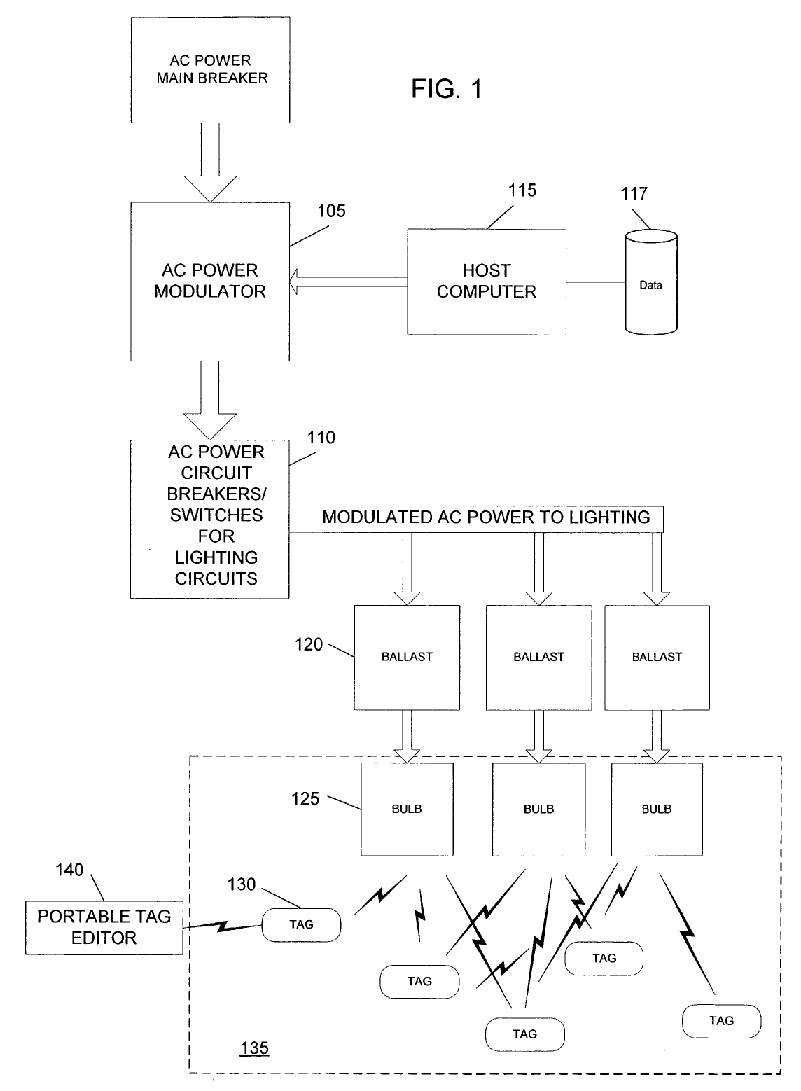

FIG. 1 is a simplified block diagram illustrating a system in accordance with one embodiment of the present invention. The system includes an AC power modulator 105 which is interposed in the Alternating Current (AC) power main which is conventionally supplied to a building or other space to be illuminated. In the United States, the AC power supplied is generally 120 VAC, 60 HZ, and may be supplied in a number of phases. The power modulator 105 is installed upstream of the power distribution point for the lighting circuits for a space to be illuminated, such as between the incoming AC power main and the circuit breaker 110 or fuse box for the lighting circuits. A host computer 115 is coupled to the AC power modulator 105 and provides data, such as from database 117, to be encoded by the power modulator 105.

In a conventional lighting system, such as fluorescent lighting, ballasts 120 are placed in line with the AC power upstream of one or more bulbs 125. In the present system, the AC power provided to the ballasts 120 is modulated in a manner that will result in variations in illumination intensity of the bulb(s) 125, such that the illumination intensity is modulated in accordance with the date to be transmitted. The modulation of the illumination intensity is preferably not perceptible to the human eye, yet is detectable by one or more optical receivers, or tags, 130 which are located in the illuminated space 135. In one embodiment, the tags 130, which will be described in further detail below, include a display device such that the received data can be conveyed to a user in text or graphical form. The system of FIG. 1 is well suited for the broadcast of data to multiple receiver endpoints, such as in the case of an electronic shelf tag system.

AC Power Modulator

A number of embodiments of AC power modulator 105 are contemplated. A common feature of each of the AC power modulator embodiments is that the AC power main signal is modulated at a point which is upstream of each of the lighting sources, and associated ballasts, that reside in the illuminated space 135.

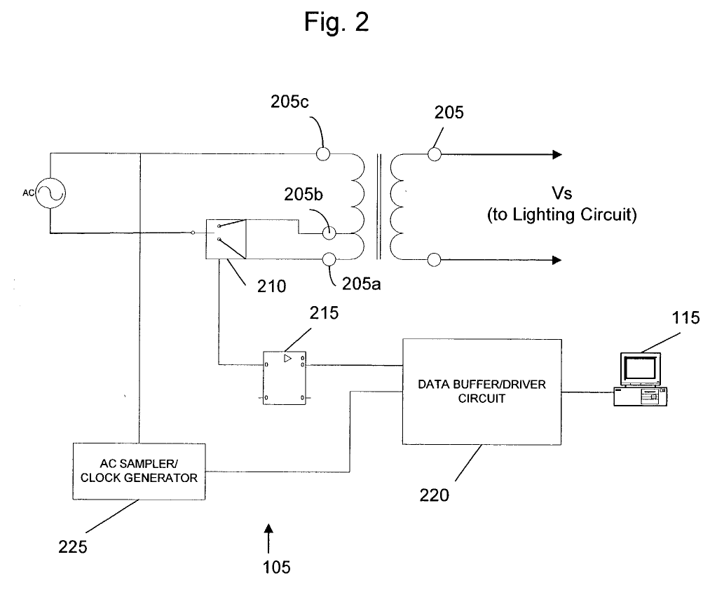

FIG. 2 is a simplified schematic diagram that illustrates a first embodiment for an AC power modulator 105. The circuit of FIG. 2 includes a transformer 205 with a tapped primary winding and a secondary winding. The tapped primary winding of transformer 205 is coupled to a switching circuit 210 which selectively couples one leg of the AC power main signal to either an outer connection 205a of the primary or the tap connection 205b of the primary winding. The second leg of the AC power main signal is connected to the primary winding connector 205c. The effect of switching the primary between the tap connector 205b and the full primary 205a is to alter the ratio of turns in the transformer primary to the transformer secondary, which is fixed. Thus, the output voltage from the secondary winding of transformer 205 is then effectively switched between two amplitudes, which can represent binary data. It will be appreciated that the desired change in the turns ratio of the transformer can also be achieved by having an untapped primary winding and a switched tapped secondary winding.

The switching circuit 210 can take various forms, such as circuits employing silicon controlled rectifiers, power MOSFET devices, relay circuits and the like. Switching between the two switch positions or states is controlled by a data signal which is preferably provided by a data buffer/driver circuit 220 that is coupled to the switching circuit via an optical isolator 215. The AC power modulator preferably includes circuitry to synchronize the data signal to the AC power main signal. In this regard, an AC power sampling circuit 225, such as a comparator, is coupled to the AC power main to derive a clock signal therefrom. For example, a 120 Hz timebase can be derived by detecting the zero crossings of a 60 HZ AC power main waveform.

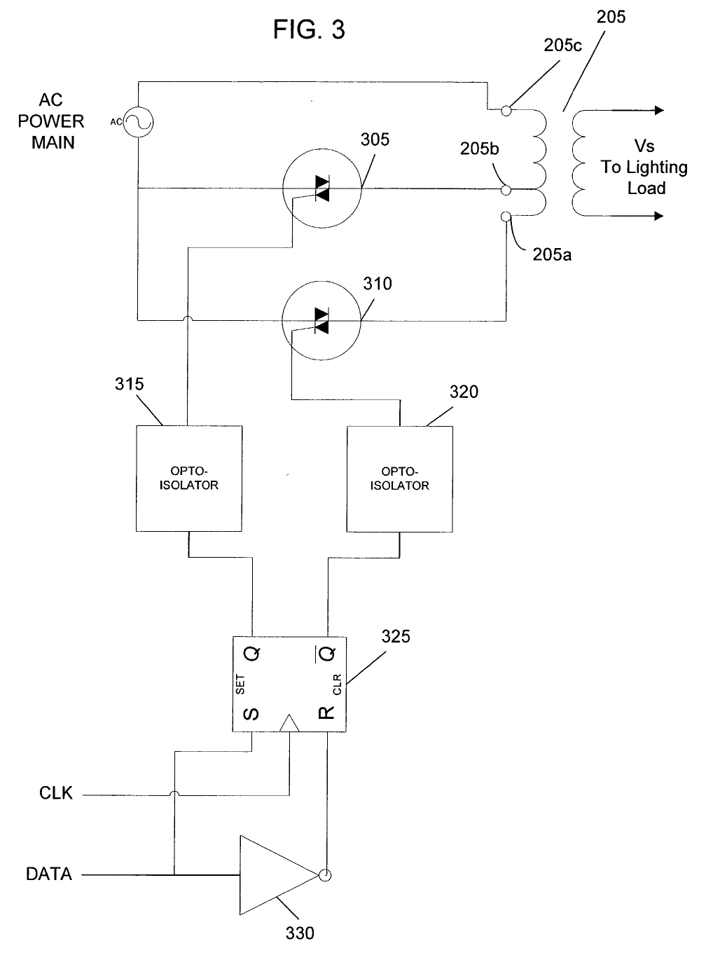

FIG. 3 is a schematic diagram illustrating an exemplary embodiment of a switching circuit 210 which uses SCR's 305, 310 as the switching elements. Referring to FIG. 3, a first SCR 305 is coupled between the tap connection 205b of the primary of transformer 205 and one leg of the AC power main. A second SCR 310 is coupled between AC power main and the outside connection 205a of the transformer primary. The gate of the first SCR 305 is coupled, via an optoisolator 315, to a Q output of a flip flop 325. Similarly, the gate of the second SCR 310 is coupled via opto-isolator 320, to the complementary, not-Q, output of the flip-flop 325. The S/R inputs of flip flop 325 are driven by a complementary signal representing the data to be transmitted which is provided by the host computer 115. The complementary signal can be derived by coupling the data signal to the S input of the flip flop as well as the input of inverter 330. The output of inverter 330 is then coupled to the R input of the flip-flop 325.

The switching of the flip-flop 325 is synchronized by the clock signal, which is generated by the AC sampler/clock generator 225 (FIG. 2). To reliably switch the SCR's 305, 310, the data should by applied to the gate terminal at a time before there is bias voltage on the SCR sufficient to maintain the SCR in the switched state. For example, the AC sampler can effectively anticipate the occurrence of the zero crossings by detecting a zero crossing and adding a time delay to the clock signal of less than about one half cycle to insure that SCRs 305, 310 are switched just prior to the following zero crossing. For a 60 HZ AC power signal, a delay time of about 8 milliseconds provides the desired half cycle delay.

In the circuit arrangement of FIG. 3, only one of the SCR's is operating in the ON state during any particular half cycle of the AC power main signal. Therefore, during each half cycle, the peak value at the secondary of transformer 205, Vs, will depend on whether the data is a binary value 1, which turns on the first SCR 305, or binary value 0, during which the second SCR 310 is turned on. The difference in peak value of Vs in each half cycle of the AC power main signal between a binary 0 and binary 1 is determined by the ratio of turns between the tapped portion of the primary winding and the full primary winding of transformer 205. Because the first SCR 305 and second SCR 310 once switched remain latched in the switched state during the full half cycle, i.e., until a zero crossing, the data rate of the switching circuit of FIG. 3 is limited to 120 bits per second (BPS). While this data rate is generally considered slow, it is adequate for many low data content broadcast systems, such as an electronic shelf tag system for use in a retail store setting, where only small amounts of information need to be transferred and the data is not particularly time sensitive (downloads can take place overnight, for example.).

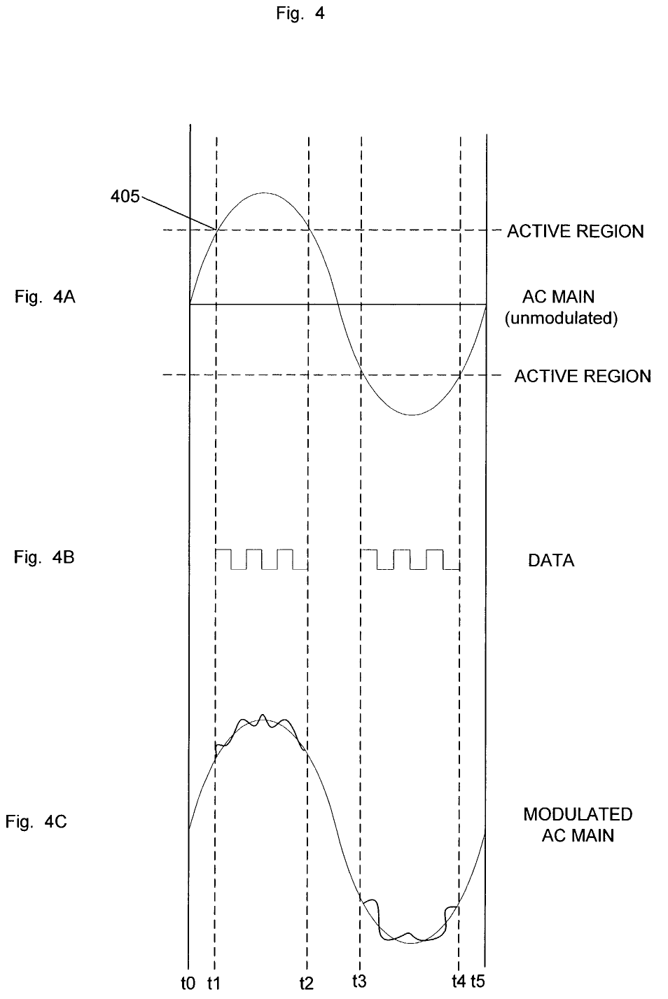

An alternative to modulating the amplitude of each half cycle of the AC power main circuit is to superimpose a higher data rate data signal on the AC power main signal. In order to generate a variation in illumination intensity, it is preferable to superimpose the modulation near the peaks of the AC power main waveform, during which the lighting sources are generally most responsive to changes in the supplied voltage. This is illustrated in the timing diagram of FIGS. 4A through 4C. FIG. 4A illustrates the timing of the unmodulated AC power main sinusoidal signal. FIG. 4B illustrates an example of data bursts which are triggered by the AC main voltage level reaching a predetermined peak voltage, such as 60 percent of the expected peak value. FIG. 4C illustrates the modulated AC power signal that is to be supplied to the lighting load which has the data imposed as amplitude modulation during the peak portions of the AC power main sine wave signal.

In the case of the timing of FIG. 4, the AC sampler circuit 225 forms a time base, or gating function, based upon a predetermined value of the AC power main waveform, as opposed to the zero crossings of the waveform. This is beneficial for it has been found that conventional illumination is particularly insensitive to transmitting detectable changes in illumination intensity near the zero crossings of the AC power main waveform. By modulating the AC main waveform after the voltage exceeds a predetermined threshold value (above or below zero), the sensitivity of the illumination source to the modulating signal is enhanced.

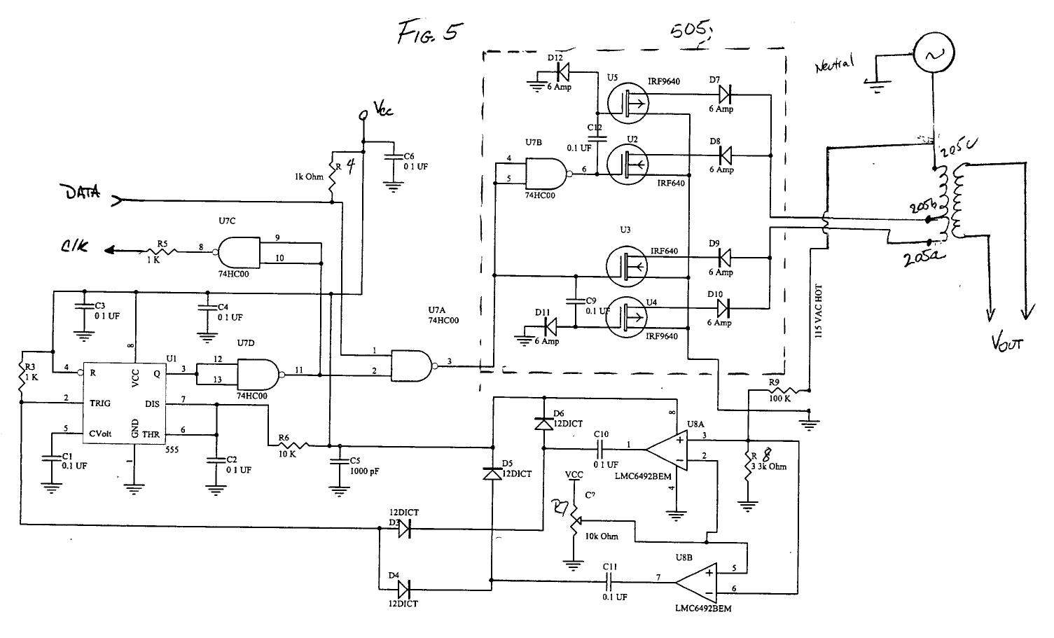

In order to modulate at data rates exceeding 120 BPS, the switch elements will take the form of non-latching switching devices, such as MOSFETs, rather than SCR's. FIG. 5 is a simplified schematic diagram which illustrates one embodiment of the AC power modulator suitable for data rates in excess of 120 BPS.

Referring to FIG. 5, the AC power main has a first leg coupled to a neutral connection and a second leg coupled to a primary connection 205C of transformer 205. The transformer has a second primary connection 205A and a tapped primary connection 205b which are alternatively coupled to the neutral AC connection via a complementary MOSFET switching circuit 505 formed with MOSFETs U2, U3, U4 and U5 and diodes D7, D8, D8, D9, D10, D11 and D12. The switching circuit 505 is controlled by a DATA signal from an external source which is coupled through NAND gate U7A. The second input of NAND gate U7A is coupled to a timing circuit which synchronizes the data signal to a predetermined portion of the AC waveform. The data signal is provided to complementary MOSFETs U3 and U4 which are coupled to transformer primary connection 205A via diodes D9 and D10, respectively. The data signal is inverted by passing the signal through NAND gate U7B and is provided in the complementary state to complementary MOSFETs U2 and U5 which are coupled to transformer tap connection 205B via diodes D8 and D7, respectively.

Timing signals for the circuit of FIG. 5 are derived by comparators U8A and U8B which are coupled to the AC power signal via the resistive voltage divider formed by resistors R8 and R9. An adjustable reference voltage for comparators U8A and U8B is provided by potentiometer R7. The comparators are arranged such that when the AC power signal sine wave exceeds the reference voltage, comparator U8B switches from high to low, momentarily pulling down the voltage on the trigger input of timing chip U1 through coupling capacitor C11. When the sine wave signal drops below the magnitude of the reference voltage, comparator U8A switches from high to low, also momentarily pulling down the voltage on the trigger input of timing chip U1 through coupling capacitor C10. Timing chip U1 can be a conventional 555 timing integrated circuit and is configured as a triggered one-shot device with a period that is by capacitors C1 and C2.

The operation of the circuit of FIG. 5 is now described in connection with the timing diagram of FIG. 4. The AC waveform is sampled by comparator U8, upon reaching the threshold voltage set by potentiometer R7, the output of comparator U8B goes low, triggering timing chip U1 such that the Q output of U1 transitions to a logic level 0 at the input of inverter U7D. This enables NAND gate U7A allowing the data signal to be passed to the switching circuit 505 during the interval from t1 to t2 (FIG. 4). When the output of U7A is high, MOSFET U3 is turned on thereby coupling primary terminal 205a to the AC neutral potential. When the data signal changes states and the output of U7A goes low, the output of U7B goes to a logic level 1. U3 is turned off and MOSFET U2 is turned on. In this state, the tap connection 205B is coupled to neutral potential, thereby changing the turns ratio of transformer 205. During the negative half of the AC sine wave cycle (t3 to t4 in FIG. 4), the operation is similar except that MOSFETs U4 and U5 perform the switching function via diodes D10 and D7 respectively.

In the circuit of FIG. 5, the MOSFET devices of switching circuit 505 are in a non-latching configuration which allows the data signal to switch the state of the circuit at a high rate with respect to the AC power signal. When modulating a conventional fluorescent lamp, the “after glow” of the phosphor that transforms the UV radiation of the mercury vapor into visible light limits the data rate to less than about 10 KBPS when the receiver used is responsive to changes in illumination in the visible spectrum. However, it is believed that by use of a receiver optimized in the ultraviolet portion (UV) of the spectrum, modulation and subsequent detection of the UV at data rates exceeding 10 KBPS is possible.

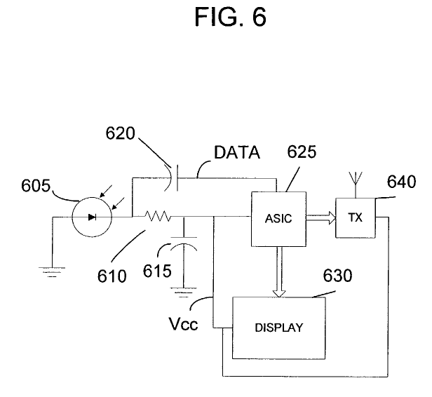

FIG. 6 is a simplified schematic diagram of an embodiment of an optical receiver, or tag, 130. The optical receiver includes a photovoltaic device 605, such as a solar cell or photo-diode. In the presence of incident light in the visible and/or ultraviolet spectrum, the photovoltaic device 605 generates a voltage which is passed through resistor 610 and charges capacitor 615. The voltage developed across capacitor 615 is used as the supply voltage, Vcc, for the tag 130. The voltage provided by photovoltaic device 605 is responsive to changes in the illumination intensity which is incident on the photovoltaic device 605. Therefore, changes in the illumination intensity resulting from the modulation of the AC power main signal are detectable as changes in the output voltage from photovoltaic device 605.

To detect and decode the data from the modulated illumination, the output of the photovoltaic device 605 is coupled, such as through capacitor 620, to a data processor which is preferably formed within an application specific integrated circuit (ASIC) 625. While not shown, one or more signal amplifiers and/or filters can be interposed between the photovoltaic device 605 and the ASIC 625. The ASIC 625 generally includes a processor operating a suitable decoding algorithm for the data format and modulation scheme employed by the system to determine the content of the received data.

In many applications, it is desirable to include a display device 630 coupled to the ASIC 625 to display text and graphics in response to the received data. For example, in a retail setting, the tags 130 can be located near products being offered for sale and the tags 130 can take the form of programmable shelf tags which are used to receive and display price and product information. The tag 130 can also include an optional data transmitter (TX) 640. The transmitter 640 can provide an acknowledgement signal or error message back to a compatible receiver that is coupled to the host computer to indicate whether valid data was received by the tag 130.

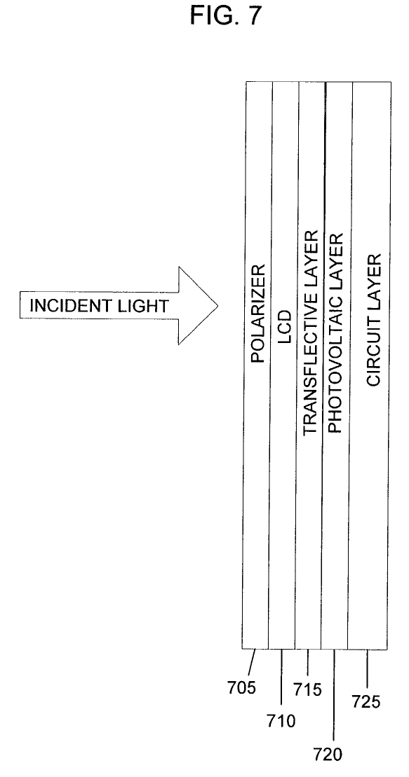

FIG. 7 is a cross sectional view of a preferred construction of an optical receiver tag 130. The illustrated construction provides an integrated and cost effective layered assembly. A front layer can take the form of a polarizer 705 which orients incident line in a specific polarization plane. Alternatively, the polarizer layer 705 can be replaced with a layer of transparent plastic or glass. Behind the front layer 705 is a liquid crystal display (LCD) layer 710 which generally includes a liquid crystal layer interposed between two transparent layers. The LCD layer 710 operates as the display device 630 (FIG. 6) for the tag 130. Behind the LCD layer 705 is a transflective layer 715. The transflective layer 715, which can take the form of a sheet of thin translucent paper, allows the majority of the incident light to pass through to a photovoltaic layer 720 but reflects enough of the incident light to provide a contrast background for the LCD display layer 710.

The transflective layer should present a minimum of about 20% transparency for the incident light to pass through it, and in many cases could be as high as 40 to 50%. The actual percentage required is determined largely by the efficiency of the photovoltaic device behind it. In the case of standard static LCD displays, a conventional back “mirror” or reflective covering (usually a sticker with reflective coating) will be removed or simply not applied and the backplane of the LCD will be coated with a transflective substance. The amount of transparency/reflectivity depends on the dilution of the substance, which is in effect a colloid with crystalloid particles suspended in an suitable emulsion. The ratio of density of colloid particles to the emulsion determines the degree of transflectance and can be easily varied according to the need for total illumination required to produced the desired average voltage.

The photovoltaic layer 720 operates as the photovoltaic device 605 in FIG. 6. Behind the photovoltaic layer 720 is a circuit layer 725 which can be formed as a flexible or rigid printed circuit board on which the electronic components of the optical tag circuit 130, such as ASIC 625, are mounted and electrically interconnected.

Referring to the system diagram of FIG. 1, when the present optical data system is used in connection with a programmable shelf tag system, it may be desirable to provide a portable tag editor 140. The portable tag editor 140 can be used to update or correct data in tags 130 by an operator in proximity to the tag. For example, if a tag is programmed to display information about product A and the shelves are subsequently changed such that product B is in that location, it would be desirable to immediately alter the information in the shelf tag 130.

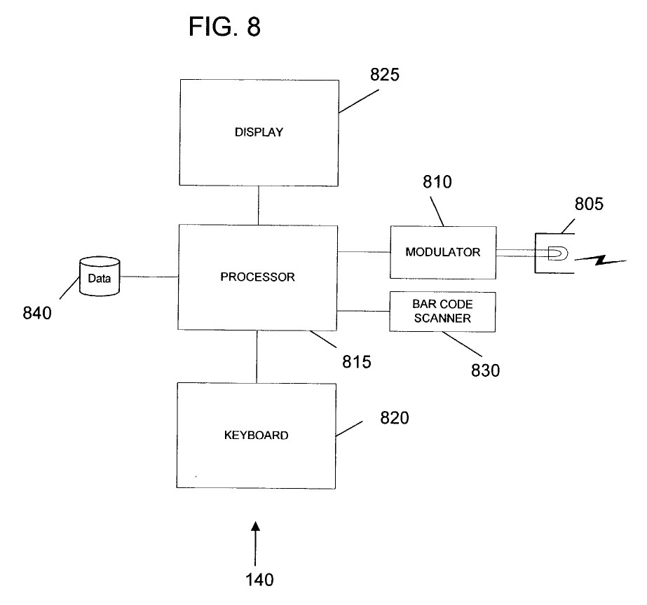

FIG. 8 is a simplified block diagram further illustrating a portable tag editor 140. The tag editor 140 preferably includes a light source 805 which can have its illumination intensity modulated 810 in a manner that is detectable and decodable by tag 130. The modulator 810 is coupled to a processor 815. The processor 810 provides the data to be sent to the tag 130 to the modulator 810. The tag editor 140 preferably includes a keyboard, or other suitable input device, for entering and editing data to be provided to the tag 130. A conventional display device 825 is coupled to the processor 815. Optionally, the tag editor 140 can include a bar code scanner to directly access product identification information, such as a UPC code, from a product. The product identification information can be used by the processor 815 to retrieve related product information, such as price, from a database 840.

The present systems and methods employ conventional artificial lighting, such as fluorescent lighting, mercury vapor lighting, incandescent lighting and the like to provide data transmission within an illuminated environment. Optical receivers are responsive to the modulated illumination and receive the data therefrom. The present system provides a cost effective communication broadcast system and is particularly well suited for use in an electronic shelf tag system.

Although the present invention has been described in connection with specific exemplary embodiments, it should be understood that various changes, substitutions and alterations can be made to the disclosed embodiments without departing from the spirit and scope of the invention as set forth in the appended claims.

What is claimed is:

1. A method of transmitting data within a network space, comprising:
illuminating the network space with a plurality of illumination sources powered by a common alternating current power main; and
applying a modulation signal to the alternating current power main such that the illumination of each of the plurality of illumination sources is simultaneously modulated in response thereto.

2. The method of transmitting data according to claim 1, wherein at least a portion of said illumination sources have an associated ballast and wherein the modulation signal is induced upstream of each of said ballasts.

3. A system for data communication in a space illuminated by a plurality of illumination sources that are powered by a common power feed, comprising:
a power modulation unit, said power modulation unit being interposed in said common power feed, upstream of each of the illumination sources, and inducing a change in the signal of said power feed in response to received data, said change effecting variations in illumination in the space provided by the illumination sources;
a data source computer, the data source computer being coupled to said power modulation unit and providing data thereto;
at least one optical receiver, said optical receiver being in optical communication with at least one of said illumination sources and being responsive to changes in incident light from said illumination sources resulting from said power modulation unit.

4. The system for data communication in a space illuminated by a plurality of illumination sources according to claim 3, wherein the power modulation unit further comprises:
AC power main input terminals for connection to an external AC power main signal;
a transformer, said transformer having first and second primary terminals, a tapped primary terminal and first and second secondary terminals, the first primary terminal being electrically coupled to the first AC power main input terminal, the first and second secondary terminals being connectable to an external illumination circuit; and
a switching circuit, the switching circuit being interposed between the AC power main input terminals and the transformer, the switching circuit selectively connecting the AC power main terminals to either the first primary and tapped primary terminals or to the first primary and second primary terminals in response to a received external data signal.

5. The system for data communication in a space illuminated by a plurality of illumination sources according to claim 3, wherein the power modulation unit further comprises:
first and second AC power main input terminals for connection to an external AC power main signal;
a transformer, said transformer having first and second primary terminals, a tapped primary terminal and first and second secondary terminals, the first primary terminal being electrically coupled to the first AC power main input terminal;
a single pole, double throw switching circuit, the pole connection of the switching circuit being operatively coupled to the second AC power main input terminal, the switching circuit having a first throw connection electrically connected to the tapped primary terminal of said transformer, the switching circuit having a second throw terminal electrically connected to the second primary terminal of said transformer; the switching circuit having a control input terminal for receiving a signal to operate the switching circuit between the two switched states of the circuit;
an AC power main sampling circuit, the AC power main sampling circuit being responsive to an applied AC power main signal applied to the AC power main input terminals and generating a clock signal therefrom; and
a data buffer circuit, the data buffer circuit having a data input terminal, a data output terminal and a clock input terminal, the data output terminal being electrically connected to the control input terminal of the switching circuit, the clock input terminal being electrically coupled to the AC power main sampling circuit, and the data input terminal is connectable to an external data source to receive data to be transmitted by the modulation unit.

6. The system for data communication in a space illuminated by a plurality of illumination sources according to claim 3, wherein the optical receiver further comprises:
a liquid crystal display layer positioned to be visible by a user;
a transflective layer positioned behind the liquid crystal display layer;
a photovoltaic layer positioned behind the liquid crystal display layer, the photovoltaic layer receiving at least a portion of the light incident upon the liquid crystal display layer; and
a circuit layer positioned behind the photovoltaic layer, the circuit layer being electrically connected to the liquid crystal display layer and the photovoltaic layer.

7. A power modulation unit which imposes a modulation signal on an AC power main signal, comprising:
AC power main input terminals for connection to an external AC power main signal;
a transformer coupled to the AC power main input terminals, said transformer having a first and second ratio of turns between a primary winding and a secondary winding;
a switching circuit operatively coupled to the transformer, the switching circuit being responsive to a signal to selectively switch between one of the first and second ratio of turns of the transformer;
modulated AC power output terminals coupled to the transformer and for external connection to a lighting load.

8. A power modulation unit which imposes a modulation signal on an AC power main signal, comprising:
first and second AC power main input terminals for connection to an external AC power main signal;
a transformer, said transformer having first and second primary terminals, a tapped primary terminal and first and second secondary terminals, the first primary terminal being electrically coupled to the first AC power main input terminal;
a single pole, double throw switching circuit having a pole connection operatively coupled to the second AC power main input terminal, the switching circuit having a first throw connection electrically connected to the tapped primary terminal of said transformer, the switching circuit having a second throw terminal electrically connected to the second primary terminal of said transformer, the switching circuit having a control input terminal for receiving a signal to operate the switching circuit between the two switched states of the circuit;
an AC power main sampling circuit, the AC power main sampling circuit being responsive to an applied AC power main signal applied to the AC power main input terminals and generating a clock signal therefrom; and
a data buffer circuit, the data buffer circuit having a data input terminal, a data output terminal and a clock input terminal, the data output terminal being electrically connected to the control input terminal of the switching circuit, the clock input terminal being electrically coupled to the AC power main sampling circuit, and the data input terminal is connectable to an external data source to receive data to be transmitted by the modulation unit.

9. The power modulation unit of claim 8, wherein the switching circuit further comprises first and second silicon controlled rectifiers (SCR), the first SCR being coupled between the second AC terminal and the tapped primary terminal, the second SCR being coupled between the second AC terminal and the second primary terminal, the gate of the first SCR is responsive to the data output signal from the data buffer circuit and the gate of the second SCR is responsive to the complement of the data output signal from the data buffer circuit.

10. The power modulation circuit of claim 9, wherein the AC sampling circuit comprises a zero crossing detector to generate said clock signal.

11. The power modulation circuit of claim 9, wherein the AC sampling circuit generates said clock signal in response to the AC power main signal having a value at least equal to a predetermined threshold value.

12. The power modulation circuit of claim 8, wherein the AC sampling circuit generates said clock signal in response to the AC power main signal having a value at least equal to a predetermined threshold value.

13. A power modulation unit which imposes a modulation signal on an AC power main signal, comprising:
AC power main input terminals for connection to an external AC power main signal;
a transformer, said transformer having first and second primary terminals, a tapped primary terminal and first and second secondary terminals, the first primary terminal being electrically coupled to the first AC power main input terminal, the first and second secondary terminals being connectable to an external illumination circuit; and
a switching circuit, the switching circuit being interposed between the AC power main input terminals and the transformer, the switching circuit selectively connecting the AC power main terminals to either the first primary and tapped primary terminals or to the first primary and second primary terminals in response to a received external data signal.

14. An optical receiver, formed in a multilayer construction, comprising:
a liquid crystal display layer positioned to be visible to a user;
a transflective layer positioned behind the liquid crystal display layer;
a photovoltaic layer positioned behind the liquid crystal display layer; and
a circuit layer positioned behind the photovoltaic layer.

15. The optical receiver of claim 14, wherein the transflective layer reflects less than 20% of the incident light.

16. The optical receiver of claim 14, wherein the transflective layer allows at least 50% of the incident light to pass through to the photovoltaic layer.

17. The optical receiver of claim 14, further comprising a radio frequency transmitter.

18. A method of providing product information at the point of product display in an illuminated space comprising:
providing an electronic product tag at the point of product display of at least one product, the electronic product tag comprising:
an optical detector for receiving data from modulated incident light;
a processor operatively coupled to said optical receiver an demodulating the received data;
a display device operatively coupled to the processor for displaying the received data in the form of product information; and
providing said modulated incident light to the optical receiver by providing a common modulating signal to the power supply of each of the illumination sources providing illumination to the space.
